(19) United States
(12) Patent Application Publication
(10) Pub. No.: US 2026/0276112 A1
(43) Pub. Date: Sep. 17, 2026

(54) EXPANDABLE HOSE AND HOSE COMPONENT

(71) Applicant: Yangjiang New Sports Technology Products Co., Ltd., Yangjiang City (CN)

(72) Inventors: Zhiqiang ZHANG, Yangjiang City (CN); Song CHEN, Yangjiang City (CN)

(73) Assignee: Yangjiang New Sports Technology Products Co., Ltd., Yangjiang City (CN)

(21) Appl. No.: 19/292,649

(22) Filed: Aug. 6, 2025

(30) Foreign Application Priority Data
Mar. 12, 2025 (CN) 202520426782.9

(51) Int. Cl. F16L 11/08; F16L 11/12

(52) U.S. Cl. CPC F16L 11/085; F16L 11/121

(57) ABSTRACT

An expandable hose and a hose component are provided. The expandable hose includes at least one layer of elastic inner hose having a drainage channel therein and being configured to axially extend and undergo a radial elastic geometric deformation and to axially retract and radially recover; an elastic braided layer tightly sleeving the elastic inner hose, the elastic inner hose and the elastic braided layer is in an interference fit state, and the elastic braided layer is configured to be driven by the elastic inner hose to axially extend and retract and to restrict a radial expansion of the elastic inner hose when the elastic inner hose undergoes a radial elastic geometric deformation; an elastic outer layer tightly sleeving the elastic braided layer and spaced apart from the elastic inner hose, the elastic outer layer is configured to deform synchronously with the elastic braided layer.

### CROSS-REFERENCE TO RELATED APPLICATION

This patent application claims the benefit and priority of Chinese Patent Application No. 202520426782.9 filed with the China National Intellectual Property Administration on Mar. 12, 2025, the disclosure of which is incorporated by reference herein in its entirety as part of the present application.

### TECHNICAL FIELD

The present disclosure relates to the technical field of hoses, in particular to an expandable hose and a hose component.

### BACKGROUND

In the traditional expandable hose, the inner hose and the outer hose are in movable clearance fit, so that the outer hose is easy to wear, and the inner hose expands rapidly after being connected to the pressure water source to produce strong friction and tearing force with the folded outer hose. At the same time, in the using process, sand, branches and other debris easily pass through the outer hose to cause fatal damage to the inner hose during the extending and retracting, thus reducing the service life of the hose.

In some technical schemes known to the inventor, a braid layer is added between the inner hose and the outer hose, and the outer hose and the inner hose are fused with each other by a region not covered by the braid layer. Although the structure can solve the problems that the inner hose is easily punctured by external sharp objects to a certain extent, when the pressure water source is connected to the inner hose and axial extending and retracting is generated, the braided layer will relatively move relative to the inner hose. When the braided layer moves, the yarns of the braided layer strongly cut the joint where the inner hose and the outer hose are fused with each other, and then the inner hose is strongly torn. The hidden dangers of water bursting and water leakage of the hose are increased, so that the service life of the hose is reduced.

Based on this, the present disclosure provides a novel expandable hose and a hose component so as to overcome the problem that an inner hose in the existing expandable hose is easily torn and destroyed by the braided layer, so that the hidden dangers of hose bursting and water leakage are increased, and the service life of the hose is reduced.

### SUMMARY

The present disclosure aims to provide a novel expandable hose and a hose component including the expandable hose so as to overcome the problem that an inner hose in the existing expandable hose is easily torn and destroyed by a braided layer, so that the hidden dangers of hose bursting and water leakage are increased, and the service life of the hose is reduced.

In order to achieve the above-mentioned purpose, the present disclosure provides the following scheme.

The present disclosure provides an expandable hose, including:
an elastic inner hose having a drainage channel therein, wherein at least one layer of elastic inner hose is provided, the elastic inner hose is configured to axially extend and undergo a radial elastic geometric deformation when fluid is introduced into the drainage channel under a pressure, and is configured to axially retract and radially recover when a pressure of drainage channel is released;
an elastic braided layer tightly sleeving an outside of the elastic inner hose, a radial circumference of the elastic inner hose being larger than a radial inner circumference of the elastic braided layer, the elastic inner hose and the elastic braided layer being in an interference fit state, and the elastic braided layer is configured to be driven by the elastic inner hose to axially extend and retract when the elastic inner hose axially extends and retracts, and is configured to restrict a radial expansion of the elastic inner hose when the elastic inner hose undergoes a radial elastic geometric deformation; and
an elastic outer layer tightly sleeving an outside of the elastic braided layer and spaced apart from the elastic inner hose by the elastic braided layer, wherein at least one layer of elastic outer layer is provided, the elastic outer layer is configured to deform synchronously with the elastic braided layer.

In some embodiments, at least one layer of elastic inner hose and at least one elastic outer layer are provided.

In some embodiments, the elastic inner hose is in the shape of a flat hose when no fluid passes through the elastic inner hose under a pressure.

In some embodiments, when the elastic inner hose is in the shape of a flat hose, a hose wall of the elastic inner hose comprises two V-shaped structures on two sides and two connecting walls, the V-shaped structures on two sides have openings opposite to each other, and ends of the openings of the two V-shaped structures are connected through the connecting walls; and wherein wall thickness a of each of the V-shaped structures is not less than thickness b of each of the connecting walls.

In some embodiments, the elastic inner hose is of an integrally extruded structure, and wherein when the elastic inner hose is in the shape of a flat hose, a distance D between tips of the V-shaped structures is 10 mm to 100 mm, and a distance H between outer sides of the connecting walls is 1.2 mm to 12 mm.

In some embodiments, a wall thickness a of each of the V-shaped structures is greater than a thickness b of each of the connecting walls, a is 0.6 mm to 5 mm, and b is 0.5 mm to 3 mm.

In some embodiments, the elastic outer layer is coated or extruded on the outside of the elastic braid layer.

In some embodiments, the elastic outer layer is of a thermoplastic elastomer structure, a natural rubber structure or a synthetic rubber structure. The elastic inner hose is of a thermoplastic elastomer structure, a natural rubber structure or a synthetic rubber structure.

In some embodiments, the elastic braided layer is of an elastically dense braided structure braided on the outside of the elastic inner hose in a stretched state of the elastic inner hose, the elastically dense braided structure is braided by first yarns, second yarns, and a plurality of stretch yarns; wherein the number of the first yarns is identical to the number of the second yarns, the first yarns and the second yarns are obliquely crossed-braided along an outer periphery of the elastic inner hose, the plurality of stretch yarns are uniformly distributed around the outer periphery of the elastic inner hose, and each of the plurality of elastic yarns is parallel to an axial direction of the elastic inner hose; and wherein each of the plurality of the stretch yarns is threaded through interwoven points formed by interweaving the first yarns and the second yarns at corresponding positions.

In some embodiments, the first yarns and the second yarns have an obliquely included angle α greater than or equal to 120° and less than 180°.

In some embodiments, the elastic braided layer is of a diamond-shaped braided structure braided on the outside of the elastic inner hose in a stretched state of the elastic inner hose, the diamond-shaped braided structure is formed by obliquely braiding the first ring-spun yarns and the ring-spun second yarns along a periphery of the elastic inner hose; and wherein the number of the first yarns is identical to the number of the second yarns.

In some embodiments, the first ring-spun yarns and the second ring-spun yarns have an obliquely included angle β greater than or equal to 120° and less than 180°.

The present disclosure also provides a hose component, including the expandable hose according to any one of the above, and at least one end of the expandable hose is provided with a joint. The joint is a female threaded connection, a ball valve water outlet or a quick connector.

The present disclosure also provides a preparation method of an expandable hose according to any one of the above, including the following steps:
matching an extruder with a suitable inner hose mold so as to prepare the elastic inner hose;
in a stretched state of the extruded elastic inner hose, wrapping the elastic braided layer on the outside of the elastic inner hose by a braiding machine; and
forming the elastic outer layer by extrusion or coating on the surface of the elastic inner hose which has been wrapped with the elastic braided layer.

Compared with the prior art, the present disclosure has the following technical effects.

The expandable hose provided by the present disclosure has the characteristics of high pressure resistance, dirt resistance, wear resistance, long service life and the like, can meet the diversified needs of users, and has the following specific beneficial effects.

Firstly, the expandable hose is not prone to water leakage and is long in service life. The elastic outer layer is not fused and connected with the elastic inner hose. Micro sliding is allowed between the elastic inner hose and the elastic braided layer during the extending and retracting of the expandable hose. The elastic braided layer has high braided density, and can basically keep a large area contact with the elastic inner hose during the extending and retracting of the hose, thus effectively resolving strong tearing force of moving yarns, avoiding the yarns from tearing the elastic inner hose, providing optimal protection for the elastic inner hose, and effectively prolonging the service life of the product.

Secondly, the expandable hose is high in pressure resistance. The elastic braided layer with limited radial elasticity is tightly wrapped around the elastic inner hose, which can provide optimal protection for the elastic inner hose.

Thirdly, the expandable hose is not prone to get dirty and resistant to wear. The elastic outer layer is wrapped around the elastic braided layer, which can protect the elastic braided layer and the elastic inner hose, and prevent foreign matter such as fine sand and gravel from entering the hose on the basis of meeting the radially and axially elastic deformation of the hose. The expandable hose has the advantages of dirt resistance and wear resistance.

In some technical schemes of the present disclosure, the elastic inner hose is of a flat structure, and undergoes a rapid elastic deformation. Residual liquid in the hose can be fully emptied when pressure is released. The expandable hose is water-saving and more environmentally-friendly. Moreover, the expandable hose is flat as a whole, is convenient to store when not in use, and is small in size and easy to carry after storage.

The hose component provided by the present disclosure, including the expandable hose, has all the characteristics of the expandable hose, and is not be repeatedly described here.

### BRIEF DESCRIPTION OF THE DRAWINGS

To more clearly illustrate the present embodiment of the present disclosure or the technical scheme in the prior art, the following briefly introduces the attached figures to be used in the present embodiment. Apparently, the attached figures in the following description show merely some embodiments of the present disclosure, and those skilled in the art can still derive other drawings from these attached figures without creative efforts.

FIG. 1 is a structural schematic diagram of an expandable hose disclosed by one or more embodiments when it does not extend and expand.

FIG. 2 is a structural schematic diagram of an expandable hose when it extends and expands under a fluid pressure as shown in FIG. 1.

FIG. 3 is a structural schematic diagram of an elastic braided layer in FIG. 1.

FIG. 4 is a schematic cross section of an expandable hose disclosed by one or more embodiments when a flat inner hose does not extend and expand.

FIG. 5 is an integral schematic cross section of a flat expandable hose disclosed by one or more embodiments.

FIG. 6 is a structural schematic diagram of an expandable hose with another elastic braided layer disclosed by one or more embodiment when it does not extend and expand.

FIG. 7 is a structural schematic diagram of an expandable hose when it extends and expands under a fluid pressure as shown in FIG. 6.

FIG. 8 is a structural schematic diagram of an elastic braided layer in FIG. 6.

FIG. 9 is a structural schematic diagram of a hose component disclosed by one or more embodiments, where both ends of the hose component are provided with female threaded connections and ball valve water outlets.

FIG. 10 is a structural schematic diagram of a hose component disclosed by one or more embodiments, where both ends of the hose component are provided with quick connectors and ball valve water outlets.

FIG. 11 is a structural schematic diagram of a hose component disclosed by one or more embodiments, where both ends of the hose component are provided with quick connectors.

FIG. 12 is a structural schematic diagram of a hose component disclosed by one or more embodiments when being coiled and stored.

FIG. 13 is a process flow diagram of an expandable hose disclosed by one or more embodiments.

### REFERENCE SIGNS IN THE ATTACHED FIGURES

100, expandable hose; 200, hose component; 300, female threaded connection; 400, ball valve water outlet; 500, quick connector;
1, elastic outer layer;
2, elastic braided layer; 21, first yarn; 22, second yarn; 23, stretch yarn; α, angle formed by oblique crossing of elastic braided layer and yarn;
3, elastic inner hose; 31, V-shaped structure; 32, connecting wall; D, flat width of flat expandable hose; a, wall thickness of V-shaped structure; b, wall thickness of connecting wall;
4, diamond-shaped braided structure; 41, first ring-spun yarn; 42, second ring-spun yarn; β, angle formed by two ring-spun yarns;
5, elastic inner hose extruder;
6, first cooling box;
7, braiding machine;
8, elastic outer layer covering machine; and
9, second cooling box.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the embodiment in the present disclosure, all other embodiments acquired by the ordinary technical staff in the art under the premise of without contributing creative labor belong to the scope protected by the present disclosure.

The present disclosure aims to provide a novel expandable hose so as to overcome the problem that an inner hose in the existing expandable hose is easily torn and destroyed by a braided layer, so that the hidden dangers of hose bursting and water leakage are increased, and the service life of the hose is reduced.

Another purpose of the present disclosure is to provide a hose component including the expandable hose.

To make the foregoing objective, features and advantages of the present disclosure clearer and more comprehensible, the present disclosure is further described in detail below with reference to the attached figures and specific embodiments.

### Embodiment I

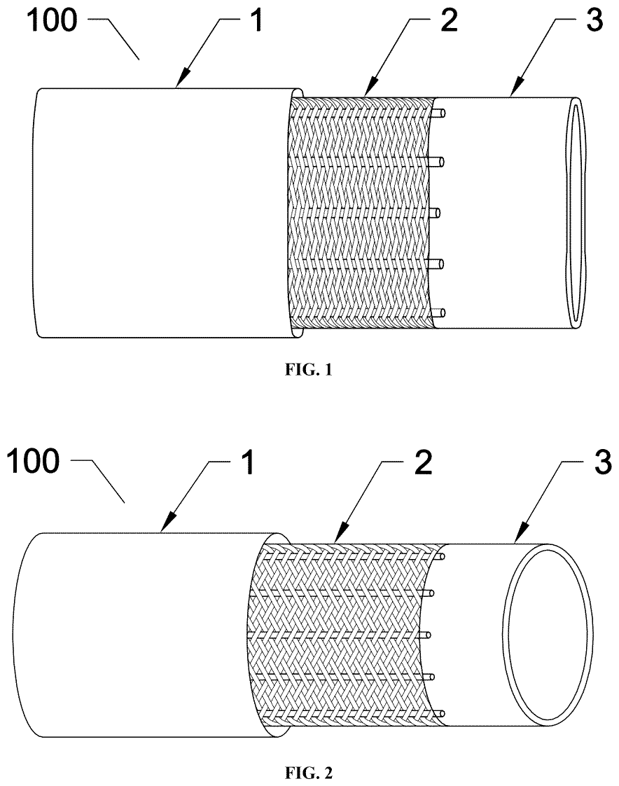

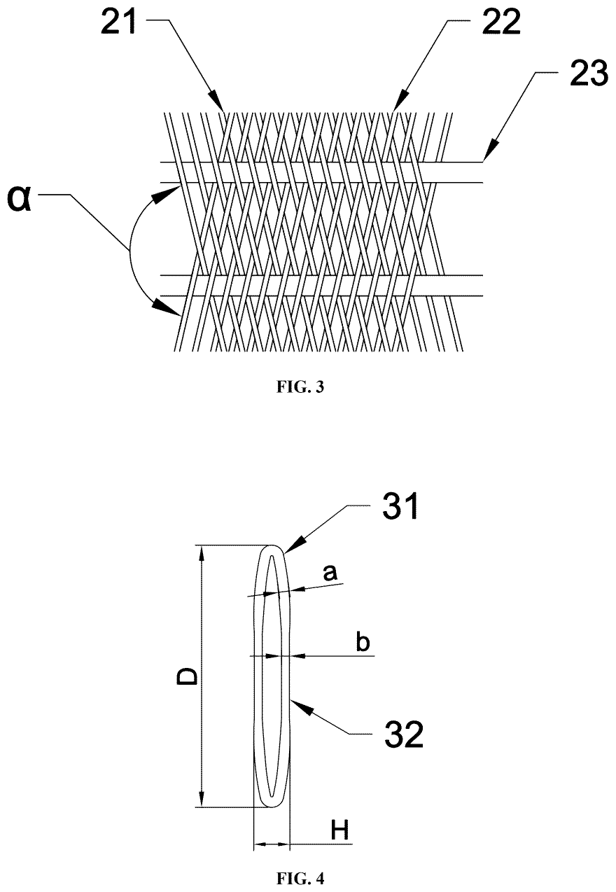

The embodiment provides a novel expandable hose 100. As shown in FIG. 1 and FIG. 2, the expandable hose includes an elastic braided layer 2, at least one layer of elastic inner hose 3 and at least one layer of elastic outer layer 1. When only one layer of elastic inner hose 3 is provided, the elastic inner hose 3 has a drainage channel therein. The elastic braided layer 2 tightly sleeves the outside of the elastic inner hose 3. The elastic braided layer 2 is of a dense and compound braided structure. The elastic braided layer 2 can be driven by the elastic inner hose 3 to axially extend and retract when the elastic inner hose 3 axially extends and retracts, and can restrict the radial expansion of the elastic inner hose 3. Usually, the radial outer circumference can be decreased or unchanged when the elastic inner hose 3 axially extends. When at least two layers of elastic inner hoses 3 are provided, multiple layers of elastic inner hoses 3 are tightly overlapped layer by layer. The drainage channel is formed inside the innermost elastic inner hose 3. The elastic braided layer 2 tightly sleeves the outside of the outermost elastic inner hose 3. The radial circumference of the elastic inner hose 3 is greater than the radial inner circumference of the elastic braided layer 2, so that the elastic inner hose 3 and the elastic braided layer 2 are in an interference fit state. Multiple layers of elastic braided layers 2 may be stacked and sleeved as necessary, but in order to ensure the stretching flexibility of the hose, preferably only one layer of elastic braided layer 2 is provided in the embodiment. The elastic outer layer 1 has high elasticity. When only one layer of elastic outer layer 1 is provided, the elastic outer layer 1 tightly sleeves the outside of the elastic braided layer 2, and the elastic outer layer 1 is spaced apart from the elastic inner hose 3 by the elastic braided layer 2. When at least two layers of elastic outer layers 1 are provided, the multiple layers of elastic outer layers 1 are tightly stacked and overlapped, and the innermost elastic outer layer 1 tightly sleeves the outside of the elastic braided layer 2. In actual production and application, the elastic outer layer 1 (or the innermost elastic outer layer 1) can be wrapped around the elastic braided layer 2 by interference fit to achieve fixation of the elastic outer layer 1 (or the innermost elastic outer layer 1) and the elastic braided layer 2. In order to ensure reliable fixation, the elastic outer layer 1 (or the innermost elastic outer layer 1) and the elastic braided layer 2 can be tightly bonded by glue. As a preferred embodiment, the present embodiment adopts a fixation scheme in which the elastic outer layer 1 (or the innermost elastic outer layer 1) and the elastic braided layer 2 are tightly bonded. At the same time, for the elastic braided layer 2 and the adjacent elastic inner hose 3, the elastic braided layer 2 is tightly and elastically wrapped around the elastic inner hose 3 preferably, but the elastic braided layer 2 is not fixedly connected to the elastic inner hose 3. When the elastic inner hose 3 expands and retracts, slightly relative sliding between the elastic braided layer 2 and the elastic inner hose 3 is allowed. Based on the above structure, the elastic inner hose 3 is tightly wrapped with the elastic braided layer 2 and has no connection with the elastic outer layer 1. Based on this, an integral expandable hose body structure with tightly combined layers is formed. The elastic inner hose 3 and the elastic outer layer 1 are not connected and are spaced apart by the elastic braided layer 2, thereby solving the problem that the joint of inner and outer hoses of the existing expandable hose is easily torn and destroyed by the braided layer, reducing the hidden dangers of hose bursting and water leakage, and prolonging the service lives of the elastic inner hose 3 and the whole hose. Wherein, the number of layers of the elastic inner hoses 3 and the elastic outer layers 1 can be adjusted according to the needs of production and application. In the following, the structure and use principle are explained by taking one layer of elastic inner hose 3 and one elastic outer layer 1 as an example.

In the expandable hose 100, the elastic inner hose 3, the elastic braided layer 2 and the elastic outer layer 1 are coupled to form an integral expandable hose through tight combination between layers, so that the hose can radially expand under the action of fluid pressure when the fluid is introduced into the drainage channel under a pressure. At the same time, limited axial elongation is realized. During pressure relief and drainage in the drainage channel, the hose can quickly contract radially and retract axially to recover to an initial state. During an extending and retracting of the hose, slight sliding exists between the elastic braided layer 2 and the elastic inner hose 3, and the slight sliding exists between the contact surfaces of the elastic braided layer 2 and the elastic inner hose 3, so that surface contact and sliding cannot cause local damage to each other, ensuring the lossless extending and retracting of the elastic inner hose 3, and prolonging the service life of the hose.

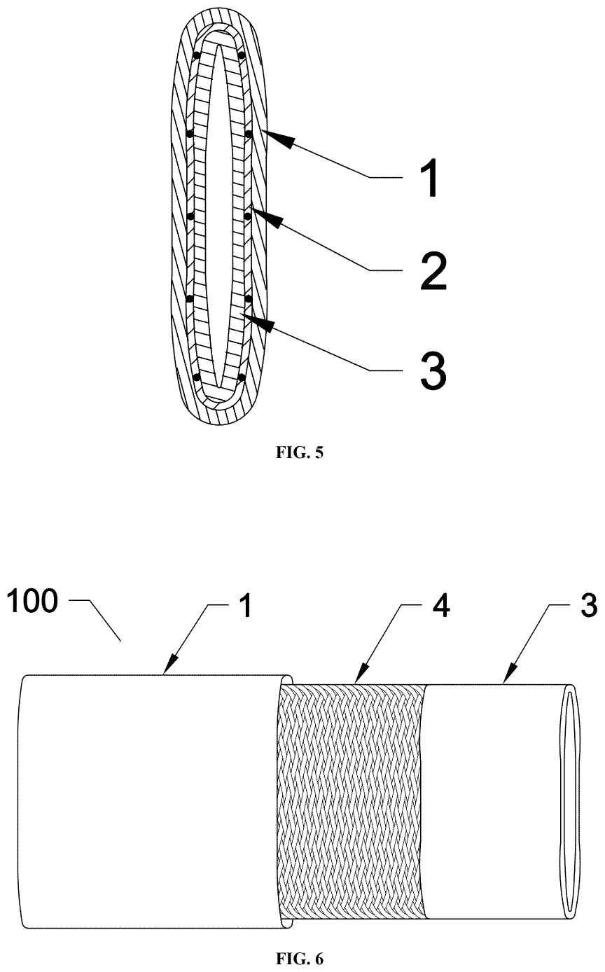

In some embodiments, when the fluid is introduced under a pressure, the elastic inner hose 3 can expand into a nearly circular hose. After pressure relief and drainage, the elastic inner hose 3 can be in the shape of a flat hose under an elastic resetting action of the elastic inner hose 3 and an elastic binding action of the elastic braided layer 2 and the elastic outer layer 1. The shape of a flat hose is a natural initial state when no water is introduced into the elastic inner hose 3, and the specific structure is shown in FIG. 1, FIG. 4 and FIG. 5. The elastic inner hose 3 having a flat tubular shape in the initial state is preferably integrally extruded by an extruder. This structural design basically does not affect the axial extending and retracting performance of the elastic inner hose 3, but the elastic inner hose 3 can radially and quickly recover to an initial flat structure when the water is discharged and the pressure is released in the hose. The water in the elastic inner hose 3 is extruded and discharged to realize the effects of water saving and environmental protection. Due to the fact that both the elastic braided layer 2 and the elastic outer layer 1 are of elastic structures, the expansion and contraction tendencies of the elastic braided layer 2 and the elastic outer layer 1 in the radial direction are basically consistent with those of the elastic inner hose 3, that is, when the elastic inner hose 3 expands into a near-circular hose or a circular hose shown in FIG. 2 when water is introduced, the elastic braided layer 2 and the elastic outer layer 1 are also near-circular hoses or circular hoses. When the elastic inner hose 3 recovers to the shape of a flat hose, the elastic braided layer 2 and the elastic outer layer 1 maintain a state of tightly fitting the elastic inner hose 3 due to an elastic reset action of the elastic braided layer 2 and the elastic outer layer 1, so that the elastic braided layer 2 and the elastic outer layer 1 are in the shape of a flat hose basically consistent with the elastic inner hose 3, as shown in FIGS. 1 and 5. At this time, the whole expandable hose 100 is in the shape of a flat hose. It should be noted that when the whole expandable hose 100 is in the shape of a flat hose as shown in FIG. 1 and FIG. 5, a gap is still formed in the elastic inner hose 3, and the elastic inner hose 3 is not completely closed, so as to ensure that the elastic inner hose 3 can quickly and geometrically deform when water is introduced again.

In some embodiments, as shown in FIG. 4 and FIG. 5, when the elastic inner hose 3 is in the shape of a flat hose, a hose wall of the elastic inner hose 3 includes V-shaped structures 31 on both sides and connecting walls 32. The V-shaped structures 31 on both sides have opposite openings, and ends of the openings of the two V-shaped structures 31 are connected via the connecting walls 32, so that a closed hose wall of the elastic inner hose 3 is formed. It should be noted that the V-shaped structures 31 and the connecting walls 32 are arranged to extend along the axial direction of the elastic inner hose 3, and the V-shaped structures 31 and the connecting walls 32 are preferably integrally formed, to ensure the integrity and elastic force uniformity of the elastic inner hose 3 and avoid breakage and water leakage due to local insufficient elasticity when the elastic inner hose 3 radially expands. The radial and geometric elasticity deformation of the elastic inner hose 3 is mainly provided by the V-shaped structures 31, that is, the radial contraction and radial expansion of the elastic inner hose 3 are mainly reflected in the change of the sizes of the openings of the V-shaped structures 31. Generally, the openings of the V-shaped structures 31 are enlarged, the included angles of the V-shaped structures 31 are increased, and then the elastic inner hose 3 expends radially; and inversely, the openings of the V-shaped structures 31 are reduced, the included angles of the V-shaped structures 31 are reduced, and the elastic inner hose 3 contracts radially.

In some embodiments, when the elastic inner hose 3 is in the shape of a flat hose, the drainage channel inside the elastic inner hose 3 is in an emptying state, and this state is also a forming state of the elastic inner hose 3. In this forming state, as shown in FIG. 4 and FIG. 5, the V-shaped structures 31 and the connecting walls 32 are of structures with uniform thickness preferably, wherein the wall thickness a of the V-shaped structures 31 are larger than the thickness b of the connecting walls 32, so that the overall hose wall of the elastic inner hose 3 is thin in the middle and thick at both ends, and the thickness transition of the joints of the connecting walls 32 and the V-shaped structures 31 are smooth. In some feasible embodiments, as shown in FIG. 4, the flat width D (that is, the distance between tips of the two V-shaped structures 31) of the elastic inner hose 3 may be 10 mm to 100 mm, and the height H (that is, the distance between outsides of the two connecting walls 32) of the elastic inner hose 3 may be 1.2 mm to 12 mm. The wall thickness a of each V-shaped structure 31 may be 0.6 mm to 5 mm, and the wall thickness b of each connecting wall 32 may be 0.5 mm to 3 mm. As a preferred embodiment, the flat width D of the elastic inner hose 3 may be 20 mm to 50 mm, and the height H of the elastic inner hose 3 may be 1.6 mm to 8 mm. The wall thickness a of each V-shaped structure 31 may be 0.8 mm to 3 mm, and the wall thickness b of each connecting wall 32 may be 0.5 mm to 2.2 mm. The elastic inner hose 3 satisfying the structure and thickness dimensions is preferably integrally extruded by a specific mold with an extruder. The shape and size of a cavity of the specific mold are matched with the elastic inner hose 3, and the specifications can be flexibly adjusted according to the adjustment of the size specifications of the elastic inner hose 3.

In some embodiments, the elastic inner hose 3 is preferably made of polymer elastic materials, including but not limited to a thermoplastic elastomer TPR, a thermoplastic elastomer TPE, TPV (thermoplastic vulcanized rubber), TPU (thermoplastic polyurethane rubber), SEBS thermoplastic elastomer, natural rubber, or other synthetic rubber.

In some embodiments, the elastic braided layer 2 is generally wrapped around and braided on the outside of the elastic inner hose 3 after the elastic inner hose 3 is stretched for a certain length (at this time, the elastic inner hose 3 radially contracts compared with the initial state as shown in FIG. 4), so as to ensure that the elastic braided layer 2 basically maintains a tight fit with the elastic inner hose 3 during the extending and retracting of the elastic inner hose 3. Based on this, when fluid is introduced into the elastic inner hose 3 under a pressure, in the radial direction, the elastic inner hose 3 can rapidly expand into a nearly circular structure as shown in FIG. 2 from a flat structure as shown in FIG. 1 within the radial limited elastic force range of the elastic braided layer 2, and the elastic braided layer 2 can restrict the elastic inner hose 3 to continue to expand radially after reaching the state as shown in FIG. 2. In the axial direction, the elastic inner hose 3 can achieve limited elongation. At the same time, the elastic braided layer 2 and the elastic inner hose 3 are in interference fit and have an interaction force, so the elastic braided layer 2 and the elastic outer layer 1 can also be driven by the elastic inner hose 3 to have a certain length of axial elongation. On the contrary, when the pressure in the elastic inner hose 3 is released, in the radial direction, the elastic inner hose 3 can quickly recover to the flat structure as shown in FIG. 1, and in the axial direction, the elastic inner hose 3, the elastic braided layer 2 and the elastic outer layer 1 can quickly retract and recover to the initial axial length. The elastic braided layer 2 is preferably of an elastically dense braided structure, and slight sliding exists between the elastic braided layer 2 and the elastic inner hose 3 during the extending and retracting of the hose.

In some feasible embodiments, the elastically dense braided structure is formed by braiding a plurality of yarns and a plurality of stretch yarns 23. Specifically, the number of yarns in the elastically dense braided structure is preferably an even number of 6 to 48, and two groups of an equal numbers of yarns are obliquely braided along the outer periphery of the elastic inner hose 3, and each yarn has a specification of 200D to 5000D. As shown in FIG. 3, the two groups of an equal number of yarns are a first group of first yarns 21 and a second group of second yarns 22, and the first yarns 21 and the second yarns 22 are staggered and braided left and right as well as up and down, and an interwoven point is formed at each intersection. A plurality of stretch yarns 23 are provided, and are uniformly distributed around the outer periphery of the elastic inner hose 3. Each stretch yarn 23 is parallel to the axial direction of the elastic inner hose 3. As shown in FIG. 3, each stretch yarns 23 is threaded through interwoven points formed by interweaving the first yarns 21 and the second yarns 22 at corresponding positions, so that the plurality of stretch yarns 23 are distributed in parallel along the axial direction in the dense braided layer and are wrapped by the dense braided layer braided by yarns. The elastically dense braided structure realizes limited radial expansion by two groups of an equal number of obliquely braided yarns, thereby restricting the expansion degree of the elastic inner hose 3 in the radial direction. At the same time, the oblique braided structure is axially arranged along the elastic inner hose 3 and matched with the stretch yarns 23, so that the elastically dense braided structure can obtain the ability of limited elongation in the axial direction. The above elastically dense braided structure can achieve limited radial expansion and limited axial elongation, and can provide optimal protection for the elastic inner hose 3. In particular, the radial expansion restriction can enable the hose to be used in high water pressure (0.6 Mpa to 1.0 Mpa) scenarios, and can achieve a long service life.

In some feasible embodiments, the elastically dense braided structure is formed by weaving n stretch yarns 23 and 2n times of yarns on the outside of the elastic inner hose 3, wherein n is a natural number, preferably 1 or 2, and the number of stretch yarns 23 may be ½ n. In the actual production application, the stretch yarn 23 can selectively be a cylindrical stretch yarn with a diameter of 0.25 mm to 2 mm, and preferably, the sizes of all stretch yarns in the elastically dense braided structure are the same. At the same time, the stretch yarns 23 are made of the materials including, but not limited to, rubber yarns or latex yarns having high elasticity, and preferably, all the stretch yarns in the elastically dense braided structure have the same material.

In some embodiments, the maximum axial elongation limit of the elastic braided layer 2 can be achieved by adjusting the angle α of the oblique yarns during weaving. As shown in FIG. 3, the angle α is set to be less than 180 degrees, but not less than 120 degrees. Within this range, the larger the value of α is, the stronger the axial elongation ability of the elastic braided layer 2 is. Preferred values of α are, but are not limited to, 140 degrees, 145 degrees, 150 degrees, and 160 degrees.

When the elastic braided layer 2 is of the elastically dense braided structure, the novel flat expandable hose can extend by 1.05 to 3 times, that is, the length in the extended state is 1.05 to 3 times of that in the unextended state.

In some embodiments, the elastic outer layer 3 is preferably made of polymer elastic materials, including but not limited to a thermoplastic elastomer TPR, a thermoplastic elastomer TPE, TPV (thermoplastic vulcanized rubber), TPU (thermoplastic polyurethane rubber), SEBS thermoplastic elastomer, natural rubber, or other synthetic rubber.

In combination with specific examples, the usage scene, usage principle and usage effect of the expandable hose 100 in the embodiment will be described in detail.

In the first usage scenario, the expandable hose 100 as a whole is a flat expandable hose as shown in FIG. 1, and is used under the action of low water pressure (0.2 Mpa to 0.4 Mpa).

The resilience force K of the elastic inner hose 3 is adjusted by adjusting the hose wall thickness of the flat elastic inner hose 3 and the tensile strength of formula material, and the wall thickness of the elastic inner hose 3 can be first set in a range relatively resistant to low water pressure, such as 0.5 mm to 1.5 mm, so as to meet the requirements that the hose is resistant to low water pressure and the inner hose is not damaged in the actual use.

The resilience force F of the elastic braided layer 2 is adjusted by adjusting the number of yarns, the yarn specifications, the number of stretch yarns 23, and the diameter of the stretch yarn 23 in the elastically dense braided structure.

The resilience force L of the elastic outer layer 1 is adjusted by adjusting the wall thickness of the elastic outer layer 1 and the tensile strength of the formula material, and the wall thickness of the elastic outer layer 1 can be first set in a range relatively resistant to wear, such as 0.5 mm to 3 mm, so as to meet the requirement that the hose is not damaged by ground friction in actual use.

When L+F+K being greater than 0 is achieved, and the closer the L+F+K value is to a value of 0, the smaller the fluid pressure required to be applied within the novel expandable hose 100 is, and the hose can expand into a nearly circular structure from a flat structure and extend axially to a set using length. According to this principle, the expandable hose 100 can be used in a low water pressure scenario. Details are described below in combination with specific examples.
(1) Preparation of the elastic inner hose 3. The elastic inner hose 3 of a flat structure is prepared from TPE low tensile strength formula materials through mold structure design of extrusion equipment. The wall thickness a of each V-shaped structure 31 is set to 0.8 mm. The wall thickness b of each connecting wall 32 is set to 0.5 mm. The flat width D of the elastic flat inner hose is 20 mm, and the flat height H is 4 mm.
(2) The number of the stretch yarns 23 of the elastic braided layer 2 is 7, and each stretch yarn 23 is a rubber latex thread with a diameter of 0.8 mm. The yarns are 28 high-strength polyester yarns of 800D, including fourteen first yarns 21 and fourteen second yarn 22. The elastic inner hose 3 is fully stretched by 5 times of the original length and then loaded into a special braiding machine (the length is stretched by 500%), and the elastic inner hose 3 is maintained in a stretched state. And then, the first yarns 21, the second yarns 22 and the stretch yarns 23 are put into the special braiding machine for braiding. The angle α at which the first yarns 21 and the second yarns 22 are obliquely crossed is set to 150 degrees during braiding, and the stretch yarns 23 are uniformly distributed in parallel along a surface of the elastic inner hose 3. Thus, an elastic braid layer 2 which achieves limited radial expansion and limited axial elongation can be produced, so that a semi-finished product of which a surface of the elastic flat inner hose is covered with the elastic braid layer 2 is obtained.
(3) The elastic outer layer 1 is made of a TPR thermoplastic elastomer material, and the extruded wall thickness of the elastic outer layer 1 is set to 0.8 mm through the mold to ensure that the thickness is sufficient to meet the demand that the hose is not damaged by ground friction in actual use. By adjusting the formula materials and using low tensile strength formula TPR raw materials, the resilience force L of the elastic outer layer and the resilience force K of the elastic inner hose 3 are low values. An elastic inner hose 3 with an elastic braided layer 2 on the surface is coated with elastic outer glue by an extruder rubber coating mold, and the elastic outer layer 1 can be obtained after cooling and shaping, and finally a novel flat expandable hose 100 is prepared. Both ends of the expandable hose 100 are equipped with joints, so that a novel flat expandable hose 100 which can be used in low water pressure scenarios (0.2 Mpa to 0.4 Mpa) is obtained, and at the same time the requirements of achieving about 2 times of limited axial elongation and long service life (wear resistance) are met.

In the second usage scenario, the expandable hose 100 as a whole is a flat expandable hose as shown in FIG. 1, and is used under the action of low water pressure (0.6 Mpa to 1.0 Mpa).

Compared with the first scenario, the high water pressure resistance of the elastic inner hose 3 is adjusted by increasing the wall thickness of the elastic inner hose 3 and adjusting the tensile strength of the formula materials. The wall thickness of the elastic inner hose 3 can be first set to a large thickness, such as 1.2 mm to 5.0 mm. The larger the tensile strength of the formula materials and the thicker the hose wall, the stronger the high pressure resistance of the produced expandable hose 100 is.

The radial and axial blowout resistance values of the elastic inner hose 3 are strengthened by adjusting the number of yarns, the yarn specifications, the number of stretch yarns 23, and the diameter of the stretch yarn 23 in the elastically dense braided structure. The more the number of yarns and the larger the yarn diameter, the greater the blowout resistance value is.

The elastically dense braided structure can limit the radial expansion of the elastic inner hose 3 and achieve limited axial elongation. The elastically dense braided structure is tightly wrapped around an outer surface of the elastic inner hose 3, so that the characteristic of limiting radial expansion (also referred to as “transverse expansion”) of the elastically dense braided structure greatly strengthens the radial blowout resistance of the elastic inner hose 3, and the characteristic of limited axial elongation of the elastically dense braided structure also greatly strengthens the axial blowout resistance of the compressible foldable elastic inner hose 3. The axial elongation limit of the elastically dense braided structure can be adjusted by the size of α of the braided yarn. According to this principle, the novel flat expandable hose meeting to be used in a high water pressure scenario can be produced. Details are described below in combination with specific examples.
(1) Preparation of the elastic inner hose 3. The elastic inner hose 3 of a flat structure is prepared from TPV high tensile strength formula materials through mold structure design of extrusion equipment. The wall thickness a of each V-shaped structure 31 is set to 2.5 mm. The wall thickness b of each connecting wall 32 is set to 2.0 mm. The flat width D of the elastic flat inner hose is 35 mm, and the flat height H is 7 mm.
(2) The number of the stretch yarns 23 of the elastic braided layer 2 is 24, and each stretch yarn 23 is a rubber latex thread with a diameter of 1.5 mm. The yarns are 48 high-strength polyester yarns of 2200D, including twenty-four first yarns 21 and twenty-four second yarn 22. The elastic inner hose 3 is fully stretched by 3 times of the original length and then loaded into a special braiding machine (the length is stretched by 300%), and the elastic inner hose 3 is maintained in a stretched state. And then, the first yarns 21, the second yarns 22 and the stretch yarns 23 are put into the special braiding machine for braiding. The angle α at which the first yarns 21 and the second yarns 22 are obliquely crossed is set to 140 degrees during braiding, and the stretch yarns 23 are uniformly distributed in parallel along a surface of the elastic inner hose 3. Thus, an elastic braid layer 2 which achieves limited radial expansion and limited axial elongation can be produced, so that a semi-finished product of which a surface of the elastic flat inner hose is covered with the elastic braid layer 2 is obtained.
(3) The elastic outer layer 1 adopts a natural latex coating process with a high tensile strength formula. The elastic inner hose 3 with the elastic braided layer 2 on the surface is coated with rubber for many times and the thickness of the rubber reaches 2 mm, and then the elastic outer layer 1 is obtained by drying, vulcanizing and shaping, and finally a novel flat expandable hose 100 is prepared. Both ends of the expandable hose 100 are respectively equipped with joints, so that a novel flat expandable hose 100 can be used in low water pressure scenarios (0.6 Mpa to 1.0 Mpa), and at the same time the requirements of achieving about 1.5 times of limited axial elongation and long service life (wear resistance) are met.

To sum up, in the expandable hose 100 proposed in this scheme, the elastic braided layer 2 can keep tight fit with the elastic inner hose 3 when the elastic inner hose 3 deforms radially and axially, and relative slight sliding is allowed between the elastic inner hose 3 and the elastic braided layer 2 during the extending and retracting of the hose. The elastic outer layer 1 is tightly adhered to an outer surface of the elastic braided layer 2. As an outer protective layer of the hose mainly, the elastic outer layer 1 is spaced apart from the elastic inner hose 3 by the elastic braided layer 2, and the elastic outer layer 1 and the elastic inner hose 3 are not connected. In production, when the elastic inner hose 3 is stretched and thinned, the elastic braided layer 2 is braided in the outside of the elastic inner hose 3, and then the elastic outer layer 1 is wrapped around the outside of the elastic braided layer 2. After the elastic inner hose 3 recovers to a natural state, the diameter of the elastic inner hose 3 is larger than that of the elastic braided layer 2, so that the elastic braided layer 2 is tightly attached to the outside of the elastic inner hose 3, and the elastic braided layer 2 and the elastic inner hose 3 are fixed by keeping tight frictional contact. The elastic inner hose 3, the elastic braided layer 2 and the elastic outer layer 1 are tightly combined, and basically extend and retract synchronously in the axial direction. In the radial direction, due to the radial restriction of the elastic braided layer 2, when the whole expandable hose is stretched in the axial direction, the radial, elastic and geometric deformation is limited, and the expandable hose is even slightly thinner compared with the initial state.

The expandable hose 100 proposed in this scheme can meet the diversified needs of users, has the characteristics of small storage volume, high pressure resistance, dirt resistance, abrasion resistance, environmental protection and water conservation, axial elongation and retraction and long service life, and has the following specific beneficial effects.

Firstly, the expandable hose 100 is high in pressure resistance. The elastic braided layer with limited radial elasticity is tightly wrapped around the outside of the elastic inner hose, which can provide optimal protection for the elastic inner hose.

Secondly, the expandable hose 100 is not prone to get dirty and resistant to wear. The elastic outer layer is wrapped around the outside of the elastic braided layer, which can protect the elastic braided layer and the elastic inner hose and prevent foreign matter such as fine sand and gravel from entering the hose on the basis of meeting the radially and axially elastic deformation of the hose. The elastic outer layer is made of a thermoplastic elastomer such as synthetic rubber, natural rubber or TPR without sediment adhesion and water absorption, and has the advantages of dirt resistance and wear resistance.

Thirdly, the expandable hose 100 is rapid in elastic deformation, water-saving and environmentally-friendly. By using an elastic inner hose with radially geometric elasticity, the elastic deformation is rapid and the service performance is good. The elastic inner hose is of a flat structure. Residual liquid in the hose can be fully emptied when the pressure is relived. The expandable hose 100 is energy-saving and environmentally-friendly.

Fourthly, the expandable hose 100 is small in size, easy to store and easy to carry. The expandable hose is flat as a whole, and is easy to store when not in use, small in size and easy to carry after storage.

Fifthly, the expandable hose is not prone to water leakage and is long in service life. The surface of the elastic inner hose is not damaged when the elastic outer layer is wrapped, and the elastic outer layer is not fused and connected with the elastic inner hose. Micro sliding is allowed between the elastic inner hose and the elastic braided layer during the extending and retracting of the expandable hose. The elastic braided layer has high braided density, and can basically keep a large area contact with the elastic inner hose during the extending and retracting of the hose, thus effectively resolving strong tearing force of moving yarns, avoiding the yarns from tearing the elastic inner hose, providing optimal protection for the elastic inner hose, and effectively prolonging the service life of the product.

### Embodiment II

As shown in FIG. 6 to FIG. 8, the embodiment provides a novel expandable hose 100. The difference between the embodiment and the first embodiment lies in that the elastic braided layer 2 in the embodiment is another dense braided layer with geometrical deformation capacity, that is, a diamond-shaped braided structure 4. The remaining structures of the expandable hose 100 in the embodiment, including the structure (including the shape and the number of layers) and the material of the elastic inner hose 3, the structure (including the shape and the number of layers) and the material of the elastic outer layer 1, the interlayer bonding mode between the elastic inner hose 3 and the elastic braided layer 2, and the interlayer bonding mode between the elastic outer layer 1 and the elastic braided layer 2, are the same as those of the first embodiment, and are not be described herein.

In some embodiments, the elastic braided layer 2 is generally wrapped around and braided on the outside of the elastic inner hose 3 after the elastic inner hose 3 is stretched for a certain length (at this time, the elastic inner hose 3 radially contracts compared with the initial state as shown in FIG. 4), so as to ensure that the elastic braided layer 2 basically maintains a tight fit with the elastic inner hose 3 during the extending and retracting of the elastic inner hose 3. Based on this, when fluid is introduced into the elastic inner hose 3 under a pressure, in the radial direction, the elastic inner hose 3 can rapidly expand into a nearly circular structure as shown in FIG. 7 from a flat structure as shown in FIG. 6 within the radial limited elastic force range of the elastic braided layer 2, and the elastic braided layer 2 can restrict the elastic inner hose 3 to continue to expand radially after reaching the state as shown in FIG. 7. In the axial direction, the elastic inner hose 3 can achieve limited elongation. The elastic braided layer 2 and the elastic outer layer 1 can also be frictionally driven by the elastic inner hose 3 to have a certain length of axial elongation. On the contrary, when the pressure in the elastic inner hose 3 is released, in the radial direction, the elastic inner hose 3 can quickly recover to the flat structure as shown in FIG. 1, and in the axial direction, the elastic inner hose 3, the elastic braided layer 2 and the elastic outer layer 1 can quickly retract and recover to the initial axial length. Slight sliding exists between the elastic braided layer 2 and the elastic inner hose 3 during the extending and retracting of the hose.

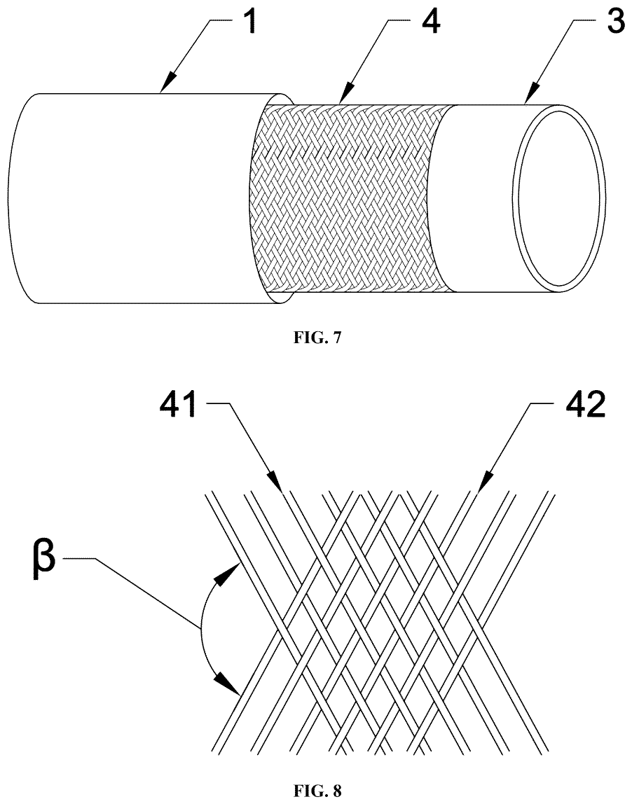

In some feasible embodiments, the diamond-shaped braided structure 4 is formed by wrapping and weaving a plurality of ring-spun yarns along the surface of the elastic inner hose 3 with a circumferentially oblique braiding method. As shown in FIG. 7, in the initial state, the diamond-shaped braided structure 4 tightly fits the surface of the elastic inner hose 3 and is in the shape of a flat hose. The number of yarns in the diamond-shaped braided structure 4 is preferably an even number of 6 to 48, and two groups of an equal numbers of yarns are obliquely braided along the outer periphery, and each yarn has a specification of 200D to 5000D. As shown in FIG. 8, the two groups of an equal number of yarns are a first group of first ring-spun yarns 21 and a second group of second ring-spun yarns 22, and the first ring-spun yarns 21 and the second ring-spun yarns 22 are staggered and braided left and right as well as up and down, and an interwoven point is formed at each intersection. The diamond-shaped braided structure 4 realizes limited radial expansion by two groups of an equal number of obliquely braided yarns, thereby restricting the expansion degree of the elastic inner hose 3 in the radial direction. At the same time, the obliquely braided structure is axially arranged along the elastic inner hose 3, so that the diamond-shaped braided structure 4 can obtain the ability of limited elongation in the axial direction to generate basically synchronous geometric deformation according to the elongation or retracting of the elastic inner hose 3. The above diamond-shaped braided structure 4 can achieve limited radial expansion and limited axial elongation, and can provide optimal protection for the elastic inner hose 3. In particular, the radial expansion restriction can enable the hose to be used in high water pressure (0.6 Mpa to 1.0 Mpa) scenarios, and can achieve a long service life.

In some embodiments, the maximum axial elongation limit of the diamond-shaped braided structure 4 can be achieved by adjusting a diagonal angle β between the ring-spun yarns during weaving. As shown in FIG. 8, the angle β is set to be less than 180 degrees, but not less than 120 degrees. Within this range, the larger the value of β is, the stronger the axial elongation ability of the diamond-shaped braided structure 4 is. Preferred values of β are, but are not limited to, 130 degrees, 140 degrees and 150 degrees.

When the elastic braided layer 2 is of the diamond-shaped braided structure 4, the novel flat expandable hose can extend by 1.05 to 2.5 times, that is, the length in the extended state is 1.05 to 2.5 times of that in the unextended state.

In combination with specific examples, the usage scene, usage principle and usage effect of the expandable hose 100 in the embodiment will be described in detail.

In the first usage scenario, the expandable hose 100 is used under the water pressure scenario of 0.3 Mpa to 0.8 Mpa.
(1) Preparation of the elastic inner hose 3. The elastic inner hose 3 of a flat structure is prepared from TPR medium tensile strength formula materials through mold structure design of extrusion equipment. The wall thickness a of each V-shaped structure 31 is set to 1.2 mm. The wall thickness b of each connecting wall 32 is set to 1.0 mm. The flat width D of the elastic flat inner hose is 25 mm, and the flat height H is 5 mm.
(2) The elastic braided layer 2 is of a diamond-shaped braided structure 4, and is specifically formed by twelve 1000D polyester high-strength yarns interwoven and knitted along the surface of the elastic inner hose 3 by a special circumferential braiding machine. The elastic braided layer 2 includes six first ring-spun yarns 41 and six second ring-spun yarns 42, and the first ring-spun yarns 41 and the second ring-spun yarns 42 form a flat gap in the axial direction of the elastic inner hose 3, so that the diamond-shaped braided structure 4 can be limited to stretch in the axial direction and expand in the radial direction. The diagonal angle β is formed between the first ring-spun yarns 41 and the second ring-spun yarns 42, and the larger the value of β is, the higher the axial and geometric deformation elongation ability of the diamond-shaped braided structure 4 is. The angle of β is set to 135 degrees, and about 1.3 times of geometric deformation can be produced with the elongation or retracting of the elastic inner hose 3.
(3) The elastic outer layer 1 adopts a synthetic latex coating process with a medium level of tensile strength formula. The elastic inner hose 3 with the diamond-shaped braided structure 4 on the surface is coated with rubber for many times and the thickness of the rubber reaches 1.0 mm, so as to ensure that the thickness is sufficient to meet the demand that the hose is not damaged by ground friction in actual use. The coated synthetic latex is dried, vulcanized and shaped to obtain the elastic outer layer 1, and finally a novel flat expandable hose 100 is obtained. Both ends of the expandable hose 100 are respectively equipped with joints, so that a novel flat expandable hose 100 which can be used in high and low water pressure scenarios of 0.3 Mpa to 0.8 Mpa is obtained, and at the same time the requirements of achieving 1.3 times of limited axial elongation and long service life (wear resistance) are met.

In the second usage scenario, the expandable hose 100 is used under the high water pressure scenario of 0.6 Mpa to 1.0 Mpa.
(1) Preparation of the elastic inner hose 3. The elastic inner hose 3 of a flat structure is prepared from PVC high elastic material through mold structure design of extrusion equipment. The wall thickness a of each V-shaped structure 31 is set to 1.8 mm. The wall thickness b of each connecting wall 32 is set to 1.5 mm. The flat width D of the elastic flat inner hose is 30 mm, and the flat height H is 7 mm.
(2) The elastic braided layer 2 is of a diamond-shaped braided structure 4, and is specifically formed by twenty-four 1000D polyester high-strength yarns interwoven and knitted along the surface of the elastic inner hose 3 by a special circumferential braiding machine. The elastic braided layer 2 includes twelve first ring-spun yarns 41 and twelve second ring-spun yarns 42, and the first ring-spun yarns 41 and the second ring-spun yarns 42 form a flat gap in the axial direction of the elastic inner hose 3, so that the diamond-shaped braided structure 4 can be limited to stretch in the axial direction and expand in the radial direction. The diagonal angle β is formed between the first ring-spun yarns 41 and the second ring-spun yarns 42, and the larger the value of β is, the higher the axial and geometric deformation elongation ability of the diamond-shaped braided structure 4 is. The angle of β is set to 130 degrees, and about 1.05 times of geometric deformation can be produced with the elongation or retracting of the elastic inner hose 3.
(3) The elastic outer layer 1 is made of a TPV high level of tensile strength formula material, and the extruded wall thickness of the elastic outer layer 1 is set to 1.2 mm through the mold to ensure that the thickness is sufficient to meet the demand that the hose is not damaged by ground friction in actual use. An elastic inner hose 3 with a diamond-shaped braided structure 4 on the surface is coated with elastic outer glue through an extruder rubber coating mold, and the elastic outer layer 1 can be obtained after cooling and shaping, and finally a novel flat expandable hose 100 is prepared. Both ends of the expandable hose 100 are respectively equipped with joints, so that a novel flat expandable hose 100 can be used in low water pressure scenarios (0.6 Mpa to 10.0Mpa), and at the same time the requirements of achieving 1.05 times of limited axial elongation and long service life (wear resistance) are met.

Thus, the expandable hose 100 proposed in this scheme can meet the diversified needs of users, has the characteristics of small storage volume, high pressure resistance, dirt resistance, abrasion resistance, environmental protection and water conservation, axial elongation and retraction and long service life, and has the following specific beneficial effects.

Firstly, the expandable hose 100 is high in pressure resistance. The elastic braided layer with limited radial elasticity is tightly wrapped around the outside of the elastic inner hose, which can provide optimal protection for the elastic inner hose.

Secondly, the expandable hose 100 is not prone to get dirty and resistant to wear. The elastic outer layer is wrapped around the outside of the elastic braided layer, which can protect the elastic braided layer and the elastic inner hose and prevent foreign matter such as fine sand and gravel from entering the hose on the basis of meeting the radially and axially elastic deformation of the hose. The elastic outer layer is made of a thermoplastic elastomer such as synthetic rubber, natural rubber or TPR without sediment adhesion and water absorption, and has the advantages of dirt resistance and wear resistance.

Thirdly, the expandable hose 100 is rapid in elastic deformation, water-saving and environmentally-friendly. By using an elastic inner hose with radially geometric elasticity, the elastic deformation is rapid and the service performance is good. The elastic inner hose is of a flat structure. Residual liquid in the hose can be fully emptied when the pressure is relived. The expandable hose 100 is energy-saving and environmentally-friendly.

Fourthly, the expandable hose 100 is small in size, easy to store and easy to carry. The expandable hose is flat as a whole, and is easy to store when not in use, small in size and easy to carry after storage.

Fifthly, the expandable hose is not prone to water leakage and is long in service life. The surface of the elastic inner hose is not damaged when the elastic outer layer is wrapped, and the elastic outer layer is not fused and connected with the elastic inner hose. Micro sliding is allowed between the elastic inner hose and the elastic braided layer during the extending and retracting of the expandable hose. The elastic braided layer has high braided density, and can basically keep a large area contact with the elastic inner hose during the extending and retracting of the hose, thus effectively resolving strong tearing force of moving yarns, avoiding the yarns from tearing the elastic inner hose, providing optimal protection for the elastic inner hose, and effectively prolonging the service life of the product.

### Embodiment III

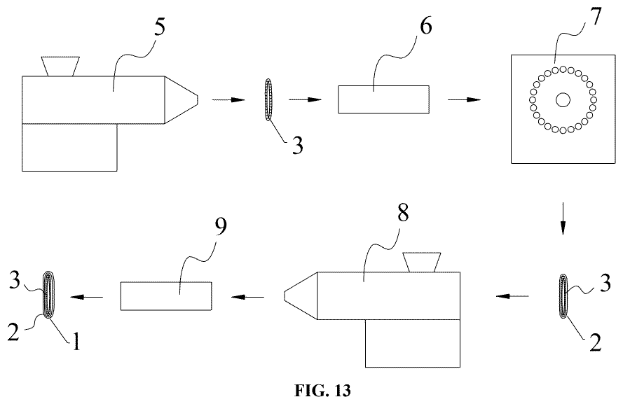

As shown in FIG. 13, the embodiment provides a preparation method of an expandable hose in the first embodiment or the second embodiment. The preparation method is mainly carried out according to the following process steps.

Firstly, the elastic inner hose 3 is prepared. An extruder is used and matched with a suitable inner hose mold to prepare the elastic inner hose 3 through direct extrusion molding. If the elastic inner hose 3 is in the shape of a flat hose as shown in FIG. 1, FIG. 4, FIG. 5 and FIG. 6, the inner hose mold is a special flat inner hose mold adapted to the shape in order to extrude the flat elastic inner hose.

Secondly, the elastic braided layer 2 is prepared on the outside of the elastic inner hose 3. The extruded elastic inner hose 3 is in a stretched state, and the elastic braided layer 2 is wrapped around the outside of the elastic inner hose 3 by a specific braiding machine. The braiding machine is a finished product braiding machine, and different types of braiding machines can be selected according to the different braiding structures of the elastic braided layer 2. The braided layer 2 may be an elastically dense braided layer of a composite structure in the first embodiment or a dense braided layer of a diamond-shaped braided structure in the second embodiment.

Thirdly, the elastic outer layer 1 is prepared on the outside of the elastic braided layer 2. The surface of the elastic inner hose 3 which has been covered with the elastic braided layer 2 (that is, the outer surface of the elastic braided layer 2) is formed into the elastic outer layer 1 by extrusion or coating. At this time, the elastic outer layer 1 and the elastic braided layer 2 are tightly combined, and are bonded in the process of extrusion or coating of the elastic outer layer 1 by using the material curing process (from liquid to solid) of the elastic outer layer 1. Thus, the interlayer bonding of the elastic inner hose 3, the elastic braided layer 2 and the elastic outer layer 1 is realized, and the preparation of the expandable hose 100 is completed. It should be noted that the shape of the expandable hose 100 prepared but not yet put into use mainly depends on the elastic inner hose 3. If the elastic inner hose 3 is extruded as a round hose, the expandable hose 100 is an expandable round hose. Similarly, if the elastic inner hose 3 is extruded as a flat hose as shown in FIG. 1, FIG. 4, FIG. 5 and FIG. 6, the expandable hose 100 is an expandable flat hose, specifically as shown in FIG. 1 and FIG. 6.

In actual operation, the preparation method of the expandable hose 100 can be implemented by a preparation system of an expandable hose, as shown in FIG. 13. The preparation system of an expandable hose includes an elastic inner hose extruder 5, a first cooling box 6, a braiding machine 7, an elastic outer layer covering machine 8 and a second cooling box 9, wherein the elastic inner hose extruder 5 is configured for extrusion molding of the elastic inner hose 3. The first cooling box 6 is mainly configured for cooling the elastic inner hose 3. The braiding machine 7 is configured for braiding the elastic braided layer 2 on the outside of the elastic inner hose 3. The elastic outer layer covering machine 8 is configured for preparing the elastic outer layer 1 on the outside of the elastic braided layer 2. The second cooling box 9 is configured for cooling and molding of the elastic outer layer 1. The elastic inner hose extruder 5, the first cooling box 6, the braiding machine 7, the elastic outer layer covering machine 8 and the second cooling box 9 are all finished products with mature technology, and will not be described here repeatedly.

### Embodiment IV

The embodiment provides a preparation method of the expandable hose 100 in the first embodiment or the second embodiment. The main difference between the first embodiment and the third embodiment is that the elastic outer layer 1 can be prepared and formed by an extruder alone. After the elastic outer layer 1 is prepared, a corresponding tool or machine is configured to sleeve elastic outer layer 1 on the surface of the elastic inner hose 3 which has been covered with the elastic braided layer 2 (that is, the outer surface of the elastic braided layer 2), and glue is filled between the elastic outer layer 1 and the elastic braided layer 2 for bonding.

### Embodiment V

The embodiment provides a hose component 200. The hose component 200 includes an expandable hose 100 disclosed in the first embodiment or the second embodiment, and at least one end of the expandable hose 100 is configured and provided with a joint. The joint may be a water inlet connecting device to connect the expandable hose 100 with a faucet. The joint may be a water outlet connecting device for connecting the expandable hose 100 to a ball valve, a water gun, or the like. The outer connector of the joint can be a quick connector, a male threaded connection or a female threaded connection to realize quick installation and use.

In some embodiments, only one end of the expandable hose 100 is configured and provided with a joint, and the joint may be one of a female threaded connection 300, a ball valve water outlet 400, and a quick connector 500. The female threaded connection 300, the ball valve water outlet 400, and the quick connector 500 are all common finished parts, and are generally inserted outside the elastic outer layer 1 of the expandable hose 100. The specific structure and use principle are not described here repeatedly.

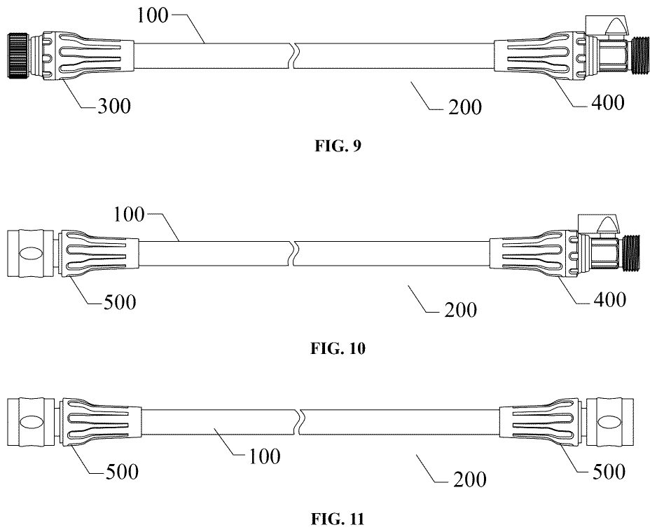

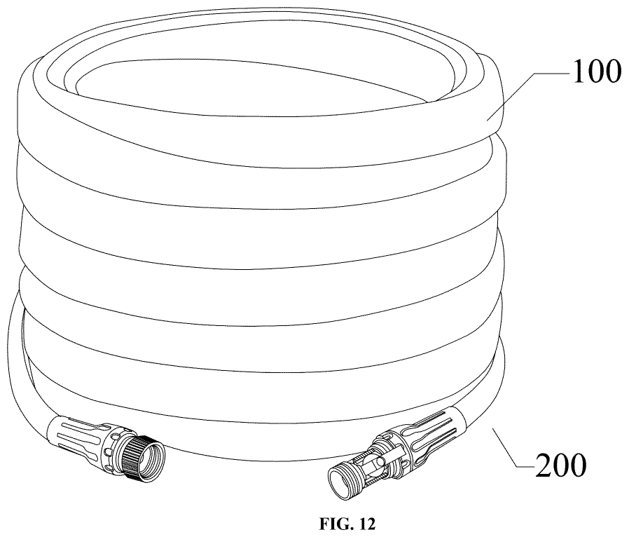

In some embodiments, both ends of the expandable hose 100 may be configured and provided with joints, respectively. The joints at both ends of the expandable hose 100 may be exactly the same, or different joints may be arranged at both ends of the expandable hose 100 according to the connecting position or use of each end of the hose. The joint at each end of the expandable hose 100 may be one of a female threaded connection 300, a ball valve water outlet 400 and a quick connector 500. As shown in FIG. 9, both ends of the expandable hose 100 are respectively configured and provided with an internally thread connector 300 and a ball valve water outlet 400. As shown in FIG. 10, both ends of the expandable hose 100 are respectively configured and provided with a ball valve water outlet 400 and a quick connector 500. As shown in FIG. 11, both ends of the expandable hose 100 are configured and provided with a quick connector 500.

When the hose component 200 is not used, the hose component is generally stored spirally, as shown in FIG. 12. Due to the flat hose design of the elastic inner hose 3, the expandable hose 100 is of a flat structure as a whole in an internal empty state. Based on this, after the hose component 200 is spiral, the volume of a coil hose can be reduced compared with the traditional circular hose hose structure of the same length, thereby saving the storage space of the hose component 200, and improving the portability and use flexibility of the hose component 200.

The hose component 200 has all the characteristics of the expandable hose 100, which are not be repeatedly described here.

The structures, proportions, sizes and the like depicted in the specification are only used for being matched with the contents disclosed in the specification for people familiar with the technology to understand and read, and are not used for limiting the implementation limiting conditions of the present disclosure, so that the practical significance, modification of any structure, change of proportional relation or adjustment of the size in the technology are avoided, and without affecting the effects and achievable objectives of the present disclosure, it should still fall within the scope of what the technical content disclosed herein can cover. The terms such as “upper”, “lower”, “left”, “right”, “middle” and “middle”, which are used in this specification, are also used for ease of description only and are not used to limit the scope of the present disclosure, and changes or adjustments in the relative relationships are considered to be the scope of the present disclosure without substantial changes in the technical content.

Specific examples are used for illustration of the principles and implementation methods of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

What is claimed is:

1. An expandable hose, comprising:
an elastic inner hose (3) having a drainage channel therein, wherein at least one layer of elastic inner hose (3) is provided, the elastic inner hose (3) is configured to axially extend and undergo a radial and elastic geometric deformation when fluid is introduced into the drainage channel under a pressure, and is configured to axially retract and radially recover when a pressure of drainage channel is released;
an elastic braided layer (2) tightly sleeving an outside of the elastic inner hose (3), a radial circumference of the elastic inner hose (3) being larger than a radial inner circumference of the elastic braided layer (2), the elastic inner hose (3) and the elastic braided layer (2) being in an interference fit state, and the elastic braided layer (2) is configured to be driven by the elastic inner hose (3) to axially extend and retract when the elastic inner hose (3) axially extends and retracts, and is configured to restrict a radial expansion of the elastic inner hose (3) when the elastic inner hose (3) undergoes a radial and elastic geometric deformation; and
an elastic outer layer (1) tightly sleeving an outside of the elastic braided layer (2) and spaced apart from the elastic inner hose (3) by the elastic braided layer (2), wherein at least one layer of elastic outer layer (1) is provided, the elastic outer layer (1) is configured to deform synchronously with the elastic braided layer (2).

2. The expandable hose according to claim 1, wherein the elastic inner hose (3) is in a shape of a flat hose when no fluid passes through the elastic inner hose (3) under a pressure.

3. The expandable hose according to claim 2, wherein when the elastic inner hose (3) is in the shape of a flat hose, a hose wall of the elastic inner hose (3) comprises two V-shaped structures (31) on two sides and two connecting walls (32), the V-shaped structures (31) on two sides have openings opposite to each other, and ends of the openings of the two V-shaped structures (31) are connected through the connecting walls (32); and wherein wall thickness a of each of the V-shaped structures (31) is not less than thickness b of each of the connecting walls (32).

4. The expandable hose according to claim 3, wherein the elastic inner hose (3) is of an integrally extruded structure, and wherein when the elastic inner hose (3) is in the shape of a flat hose, a distance D between tips of the V-shaped structures (31) is 10 mm to 100 mm, and a distance H between outer sides of the connecting walls (32) is 1.2 mm to 12 mm.

5. The expandable hose according to claim 3, wherein a wall thickness a of each of the V-shaped structures (31) is greater than a thickness b of each of the connecting walls (32), a is 0.6 mm to 5 mm, and b is 0.5 mm to 3 mm.

6. The expandable hose according to claim 1, wherein the elastic outer layer (1) is coated or extruded on the outside of the elastic braid layer (2).

7. The expandable hose according to claim 1, wherein the elastic outer layer (1) is of a thermoplastic elastomer structure, a natural rubber structure or a synthetic rubber structure; and wherein the elastic inner hose (3) is of a thermoplastic elastomer structure, a natural rubber structure or a synthetic rubber structure.

8. The expandable hose according to claim 1, wherein the elastic braided layer (2) is of an elastically dense braided structure braided on the outside of the elastic inner hose (3) in a stretched state of the elastic inner hose (3), the elastically dense braided structure is braided by first yarns (21), second yarns (22), and a plurality of stretch yarns (23); wherein a number of the first yarns (21) is identical to a number of the second yarns (22), the first yarns (21) and the second yarns (22) are obliquely crossed-braided along an outer periphery of the elastic inner hose (3), the plurality of stretch yarns (23) are uniformly distributed around the outer periphery of the elastic inner hose (3), and each of the plurality of elastic yarns (23) is parallel to an axial direction of the elastic inner hose (3); and wherein each of the plurality of the stretch yarns (23) is threaded through interwoven points formed by interweaving the first yarns (21) and the second yarns (22) at corresponding positions.

9. The expandable hose according to claim 8, wherein the first yarns (21) and the second yarns (22) have an obliquely included angle α greater than or equal to 120° and less than 180°.

10. The expandable hose according to claim 1, wherein the elastic braided layer (2) is of a diamond-shaped braided structure (4) braided on the outside of the elastic inner hose (3) in a stretched state of the elastic inner hose (3), the diamond-shaped braided structure (4) is formed by obliquely braiding the first ring-spun yarns (41) and the ring-spun second yarns (42) along a periphery of the elastic inner hose (3); and wherein a number of the first yarns (41) is identical to a number of the second yarns (42).

11. The expandable hose according to claim 10, wherein the first ring-spun yarns (41) and the second ring-spun yarns (42) have an obliquely included angle β greater than or equal to 120° and less than 180°.

12. A hose component, comprising the expandable hose (100) according to claim 1, wherein at least one end of the expandable hose (100) is provided with a joint; and wherein the joint is a female threaded connection (300), a ball valve water outlet (400) or a quick connector (500).

13. The hose component according to claim 12, wherein the elastic inner hose (3) is in a shape of a flat hose when no fluid passes through the elastic inner hose (3) under a pressure.

14. The hose component according to claim 13, wherein when the elastic inner hose (3) is in the shape of a flat hose, a hose wall of the elastic inner hose (3) comprises two V-shaped structures (31) on two sides and two connecting walls (32), the V-shaped structures (31) on two sides have openings opposite to each other, and ends of the openings of the two V-shaped structures (31) are connected through the connecting walls (32); and wherein wall thickness a of each of the V-shaped structures (31) is not less than thickness b of each of the connecting walls (32).

15. The hose component according to claim 14, wherein the elastic inner hose (3) is of an integrally extruded structure, and wherein when the elastic inner hose (3) is in the shape of a flat hose, a distance D between tips of the V-shaped structures (31) is 10 mm to 100 mm, and a distance H between outer sides of the connecting walls (32) is 1.2 mm to 12 mm.

16. The hose component according to claim 14, wherein a wall thickness a of each of the V-shaped structures (31) is greater than a thickness b of each of the connecting walls (32), a is 0.6 mm to 5 mm, and b is 0.5 mm to 3 mm.

17. The hose component according to claim 12, wherein the elastic outer layer (1) is coated or extruded on the outside of the elastic braid layer (2).

18. The hose component according to claim 12, wherein the elastic outer layer (1) is of a thermoplastic elastomer structure, a natural rubber structure or a synthetic rubber structure; and wherein the elastic inner hose (3) is of a thermoplastic elastomer structure, a natural rubber structure or a synthetic rubber structure.

19. The hose component according to claim 12, wherein the elastic braided layer (2) is of an elastically dense braided structure braided on the outside of the elastic inner hose (3) in a stretched state of the elastic inner hose (3), the elastically dense braided structure is braided by first yarns (21), second yarns (22), and a plurality of stretch yarns (23); wherein a number of the first yarns (21) is identical to a number of the second yarns (22), the first yarns (21) and the second yarns (22) are obliquely crossed-braided along an outer periphery of the elastic inner hose (3), the plurality of stretch yarns (23) are uniformly distributed around the outer periphery of the elastic inner hose (3), and each of the plurality of elastic yarns (23) is parallel to an axial direction of the elastic inner hose (3); and wherein each of the plurality of the stretch yarns (23) is threaded through interwoven points formed by interweaving the first yarns (21) and the second yarns (22) at corresponding positions.

20. The hose component according to claim 19, wherein the first yarns (21) and the second yarns (22) have an obliquely included angle α greater than or equal to 120° and less than 180°.
